(19) United States
(12) Patent Application Publication
(10) Pub. No.: US 2014/0149070 A1
(43) Pub. Date: May 29, 2014

(54) METHOD AND SYSTEM FOR ANALYZING MOVEMENT TRAJECTORIES

(71) Applicant: INDUSTRIAL TECHNOLOGY RESEARCH INSTITUTE, (US)

(72) Inventors: KUANG-HUNG CHENG, Tainan City (TW); SHUN-CHIEH LIN, Tainan City (TW); HUAN-WEN TSAI, Hsinchu City (TW)

(73) Assignee: INDUSTRIAL TECHNOLOGY RESEARCH INSTITUTE, Hsin-Chu (TW)

(21) Appl. No.: 13/771,218

(22) Filed: Feb. 20, 2013

(30) Foreign Application Priority Data
Nov. 23, 2012 (TW) 101143921

(51) Int. Cl. G06F 17/00

(52) U.S. Cl. CPC G06F 17/00
USPC 702/150

(57) ABSTRACT

The present disclosure relates to a method and system for analyzing movement trajectories. The method comprises: recording a plurality of movement trajectories and each movement trajectory includes a position coordinate generated by at least two signals with different accuracies and classification; generating a plurality of Regions of Interest (ROIs) according to the movement trajectories; generating a plurality of corresponding relationships and a multi-level data according to the plurality of ROIs; and comparing the multi-level data with a historical data.

### CROSS REFERENCE TO RELATED APPLICATION

This application also claims priority to Taiwan Patent Application No. 101143921 filed in the Taiwan Patent Office on Nov. 23, 2012, the entire content of which is incorporated herein by reference.

### TECHNICAL FIELD

The present disclosure relates to a method and system for analyzing movement trajectories, and more particularly, to a movement analysis method and system designed to perform an analysis based upon location classification and a plurality of positioning signals from various sources of different accuracies.

### BACKGROUND

Nowadays, with location-aware devices (such as GPS receivers, cell phones, and radio telemetry) and various data collection platforms, massive data sets of trajectories have become available. The analysis of such trajectory data is a critical component in a wide range of applications, such as mobile service recommendation systems and mobile social networking systems. Most previous works on trajectory analysis only adopts one single type of positioning signal in their analysis, but nowadays, since more and more target mobile objects are equipped with various location-aware devices at the same time for broadcasting accurate information about their movements, the resulting data sets of trajectories can be the mixture of various positioning signals, including GPS signals, WiFi signals, GSM signals, QR-Code with location information, etc. Current trajectory analysis techniques are generally lack of the ability to simultaneously analyze different positioning signals in a trajectory data set for correspondingly locating Regions of Interest (ROIs) of different accuracies. Moreover, there is also no method that is currently available to be used for integrating ROIs of different accuracies in order to deduce meaningful information therefrom.

### SUMMARY

The present disclosure provides a method for analyzing movement trajectories, which comprises the steps of: recording a plurality of movement trajectories; generating a plurality of Regions of Interest (ROIs) according to the plural movement trajectories; generating a multi-level data according to the plurality of ROIs.

The present disclosure provides a system or analyzing movement trajectories, which comprises: a database, for storing a plurality of movement trajectories; and a servo device, for generating a plurality of Regions of Interest (ROIs) according to the plural movement trajectories and then for generating a plurality of corresponding relationships and a multi-level data according to the plurality of ROIs.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a flow chart depicting steps performed in a method for analyzing movement trajectories according to an exemplary embodiment of the present disclosure.

FIG. 2A is a schematic diagram showing exemplary movement trajectories of mobile objects A and B.

FIG. 2B is a schematic diagram showing a multi-level ROI data generated for representing the movement trajectories of the mobile objects A and B of FIG. 2A.

FIG. 3A shows the corresponding relationships induced from the multi-level ROI data of FIG. 2B.

FIG. 3B shows the corresponding relationships induced from the multi-level ROI data of FIG. 2B in semantic levels.

FIG. 4 is a flow chart depicting steps performed in a method for analyzing movement trajectories according to an exemplary embodiment of the present disclosure, that includes a steps for comparing the multi-level data with a historical data so as to determine and predict the position of a mobile object.

FIG. 5 is a flow chart depicting steps performed in a clustering analysis for establishing a multi-level data of ROI clusters.

FIG. 6 is flow chart depicting steps for establishing a multi-level ROI data of hierarchical structure and a multi-level ROI trajectory database.

FIG. 7 is a block diagram showing a system for analyzing movement trajectories according to an exemplary embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

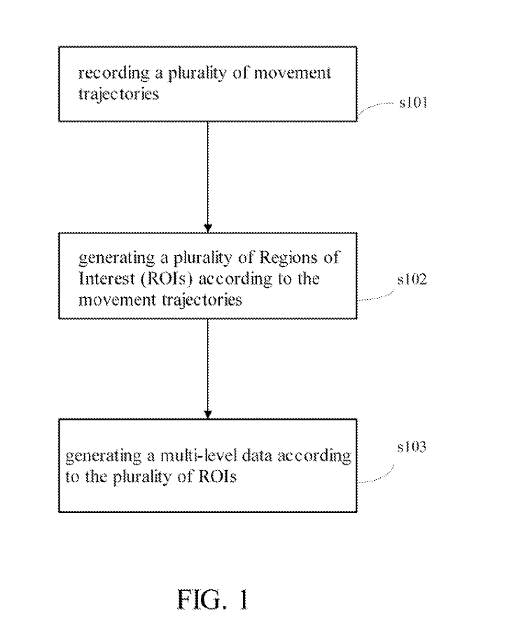

Please refer to FIG. 1, which is a flow chart depicting steps performed in a method for analyzing movement trajectories according to an exemplary embodiment of the present disclosure. As shown in FIG. 1, the trajectory analysis method starts from the step s101. At the step s101, there is a plurality of movement trajectories being recorded; and then the flow proceeds to step s102. At step s102, there is a plurality of Regions of Interest (ROIs) being generated according to the movement trajectories; and then the flow proceeds to step s103. At step s103, there is a data being generated according to the plural ROIs. In this embodiment, each of the plural movement trajectories includes at least two positioning signals of different accuracies, times, dates, position coordinates and location classifications (semantic classifications), etc., whereby, the plural ROIs can be sequencing by time. It is noted that the data generated at step s103 is a multi-level data of hierarchical structure; and the plural ROIs can be generated using a clustering algorithm or a space partitioning approach. Moreover, the location classifications include school, playground, restaurant, home, and so on, and as a consequence, the semantic classifications include depictions of the aforesaid location classifications.

In this embodiment, when there are a plurality of mobile objects required to be tracked, each and every one of the plural mobile objects must be fitted with a location-aware device that is designed with an ability to receive a variety types of positioning signals for position locating. It is noted that a trajectory is a sequence of sampled locations and time stamps along the route of a mobile object, whereas the sampled locations of the same trajectory can be obtained based upon the same type of positioning signals of the same accuracies, or different types of positioning signals of different accuracies, and each of the sampled locations is classified into their respective semantic classifications. According to those positioning signals, the trajectory of each of the plural mobile objects that includes a sequence of sampled locations, time stamps, dates and position coordinates can be tracked and recorded. Moreover, the aforesaid location-aware device can be a smart phone, a notebook computer, a tablet computer, etc., whichever is equipped with positioning capability. After the recording of the plural trajectories, those trajectories are analyzed so as to establish a plurality of ROIs of multi-level hierarchical structure. In an embodiment, the trajectories that includes positioning signals of different accuracies are analyzed using a clustering algorithm or a space partitioning approach so as to generate a plurality of ROIs of multi-level hierarchical structure, while simultaneously enabling the plural multi-level ROIs to be sequencing by time according to their respective time stamps. Specifically, ROIs at different levels in the multi-level structure can be converted and corresponding to one another, and as a consequence, the penetrability of each ROI in the multi-level structure can be calculated so as to establish and relate a multi-level structure of various accuracies to the plural multi-level ROIs. Thereby, the trajectory of each moving object can be converted into a multi-level data of hierarchical structure that is related directly to the moving object. Since the multi-level data of hierarchical structure includes a complete corresponding relationships between ROIs of different accuracies, it can be used for extracting meaning moving pattern of the mobile object. The levels of hierarchy in the hierarchical structure are established and determined according to the types of the different positioning signals or according to the location classification or semantic classification.

In addition, the positioning signals of different accuracies include: GPS signals, WiFi signals, GSM signals, GPRS signals, QR-Code with location information, NFC signals and RFID signals, but are not limited thereby. Other than the GPS signals and the QR-Code, all the other signals are specified by their respective data transmission protocols and are used in positioning applications. Generally, the accuracy resulting from the signals of GSM/3G/GPRS is within 1000 m˜2000 m, representing that the error in corresponding position coordinate is within 1000 m˜2000 m. Similarly, the error in WiFi position coordinate is within 50 m˜100 m; the error in GPS position coordinate is within 5 m˜10 m; the errors in QR-Code position coordinate, NFC position coordinate and RFID position coordinate are all within 1 m.

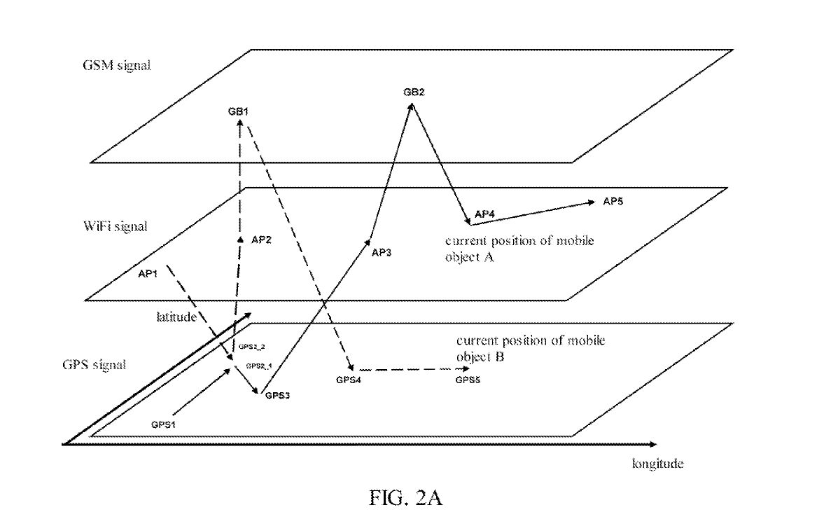

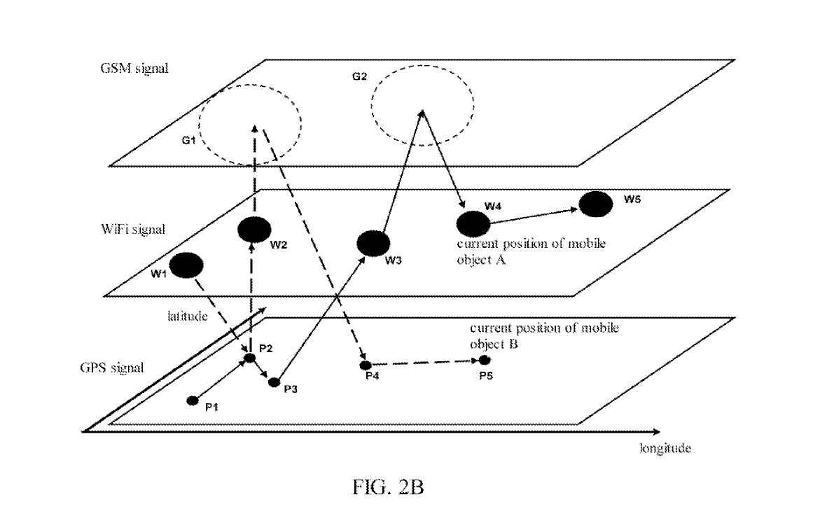

Please refer to FIG. 2A, which is a schematic diagram showing exemplary movement trajectories of mobile objects A and B. In the embodiment shown in FIG. 2A, there are two mobile objects A and B that each is fitted with a location-aware device to be used for registering at each sampled location on the route a plurality of positioning signals of different accuracies so as to record the time stamps and position coordinated for each sampled location along the route of its corresponding mobile object A or B. In this embodiment, the location-aware devices are designed to receive GPS signals, WiFi signals and GSM signals. At the starting of mobile object A, the location-aware device on the mobile object A can receive GPS signals and thus it records there GPS position coordinates of the first three sequential sampled locations as GPS1, GPS2_{—}1 and GPS3. After moving passing the sampled location GPS3, the location-aware device loses its connected to GPS signal, but instead establishes a connection to a WiFi access point that is identified as AP3 at another sampled location after GPS3, and thereafter, the connection to the AP3 is lost and another connection with a GSM station that is identified as GB2 is established at another sampled location after AP3. Consequently, a trajectory of mobile object A can be established as following: GPS1→GPS2_{—}1→GPS3→AP3→GB2→AP4→AP5. On the other hand, for the mobile object B, its trajectory is recorded as following: AP1=GPS2_{—}2→AP2→GB1→GPS4→GPS5. It is noted that in the present embodiment, at the same sampled location where there are two positioning signals of different accuracies available, the one positioning signal with higher accuracy will be adopted in the trajectory record, but is mot limited thereby.

A clustering algorithm is used in the present disclosure for analyzing trajectories of three common positioning signals, i.e. GPS signals, WiFi signals and GSM signals, so as to generate a plurality of ROIs of multi-level hierarchical structure. The positioning signals for the present disclosure are not limited by the aforesaid there common signals, but it is required to have at least two different positioning signals. Please refer to FIG. 2B, which is a schematic diagram showing a multi-level ROI data generated for representing the movement trajectories of the mobile objects A and B of FIG. 2A. The GPS position coordinates: GPS1, GPS2_{—}1, GPS2_{—}2, GPS3, GPS4 and GPS5 are clustered in a GPS-level ROI cluster as P1, P2, P3, P4 and P5 in respective; the WiFi position coordinates: AP1, AP2, AP3, AP4, and AP5 are clustered in a WiFi-level ROI cluster as W1, W2, W3, W4 and W5; and the GSM position coordinates: GB1 and GB2 are clustered in a GSM-level ROI cluster as G1 and G2. Thus, the trajectory of mobile object A can be established as following: P1→P2→P3→W3→G2→W4→W5; and the trajectory of mobile object B can be established as following: W1→P2→W2→G1→P4→P5.

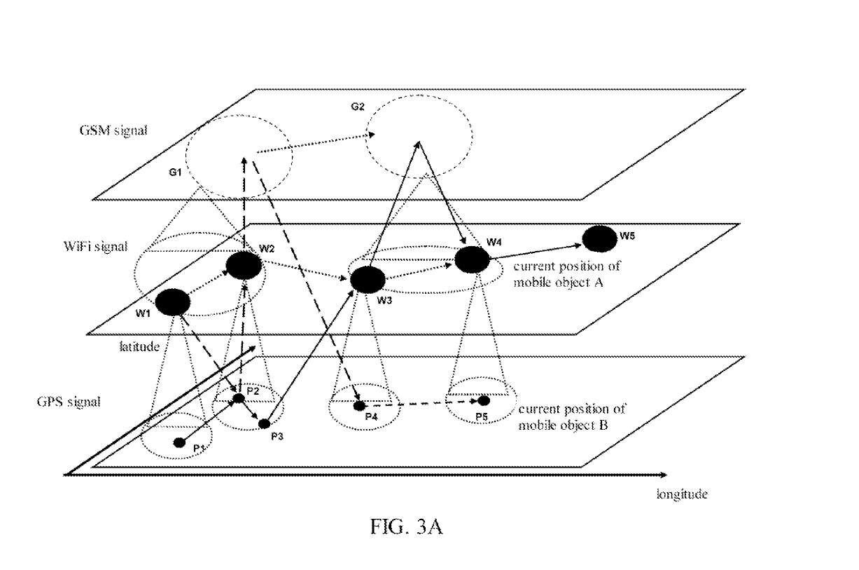

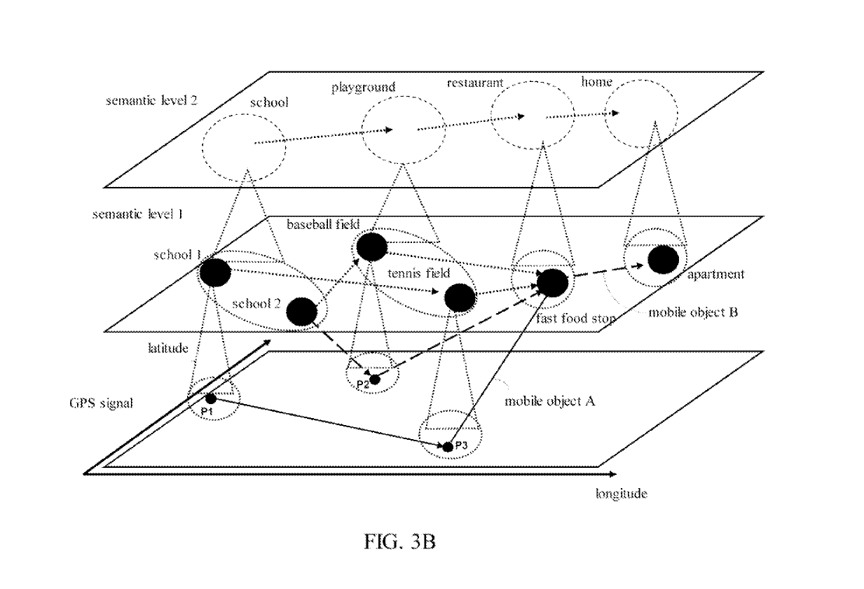

Thereafter, the penetrability of each ROI in the multi-level structure is calculated and used for establishing corresponding relationships between ROIs in different cluster levels of the hierarchical structure. As shown in FIG. 3, P1 is corresponding to W1, W1 is corresponding to G1, P2 and P3 are corresponding to W2, W2 is corresponding to G1, P4 is corresponding to W3, P5 is corresponding to W4, and W3 and W4 are corresponding to G2. Thereby, the trajectory of the mobile object A is converted into a multi-level data of hierarchical structure, and in this embodiment, the trajectory of the mobile object A is converted into a multi-level data of hierarchical structure which comprises three levels, i.e. a GPS level: P1→P2→P3;

a WiFi level: W1→W2→W3→W4→W5; and a GSM level: G1→G2. Similarly, the trajectory of the mobile object B is converted into another multi-level data of hierarchical structure which comprises three levels, i.e. a GPS level: P2→P4→P5; a WiFi level: W1→W2→W3→W4; and a GSM level: G1→G2. Both of the two multi-level data of hierarchical structure are respectively includes a complete corresponding relationships between ROIs of different accuracies that can be used for extracting meaning moving patterns of the corresponding mobile objects, but are not limited thereby. In this embodiment, the WiFi level trajectory of mobile object B is similar to the WiFi level trajectory of mobile object A, so that a prediction can be established that the mobile object B is about to move to W5 right after W4.

Furthermore, the present disclosure adopts a clustering algorithm for clustering the multi-level ROIs of hierarchical structure, whereas the base for clustering in the clustering algorithm is not necessary to be a geographical coordinates. As shown in FIG. 3, the GPS level ROIs that are clustering based upon geographical coordinates are P1˜P3, while the ROIs in semantic level 1 that are clustering based upon semantic description are: School 1, School 2, Baseball field, Tennis field, Fast food stop and Apartment, and the ROIs in semantic level 2 that are clustering based upon semantic description are: School, Playground, Home. Thereby, the trajectory of mobile object A can represented as following: P1→P9→Fast food stop, and the trajectory of mobile object B can represented as following: School 2→P2→Fast food stop→Apartment. Moreover, the corresponding relationships between ROIs in different cluster levels that are established according to the penetrability of each ROI in the multi-level structure are also not necessary to be based upon the geographical coordinates, and instead can be established based upon semantic relations, by that P1 is corresponding to School 1, P2 is corresponding to baseball field, P3 is corresponding to Tennis field; and in addition, School 1 and School 2 are corresponding to School, Baseball field and Tennis Field are corresponding to Playground, Fast food stop is corresponding to Restaurant, and Apartment is corresponding to Home. Consequently, the trajectory of the mobile object A is converted into a multi-level data of hierarchical structure which comprises three levels, i.e. a GPS level: P1→P3; a semantic level 1: School 1→Tennis field→Fast food stop; and a semantic level 2: School→Playground→Restaurant. Similarly, the trajectory of the mobile object B is converted into another multi-level data of hierarchical structure which comprises three levels, i.e. a GPS level: P2; a semantic level 1: School 2→Baseball field→Fast food stop→Apartment; and a semantic level 2: School→Playground→Restaurant→Home. Both of the two multi-level data of hierarchical structure are respectively includes a complete corresponding relationships between ROIs of different semantic levels that can be used for extracting meaning moving patterns of the corresponding mobile objects. In this embodiment, the trajectory of mobile object A in semantic level 2 is similar to the trajectory of mobile object B in semantic level 2, so that a prediction can be established that the mobile object A is about to move to Home right after Restaurant.

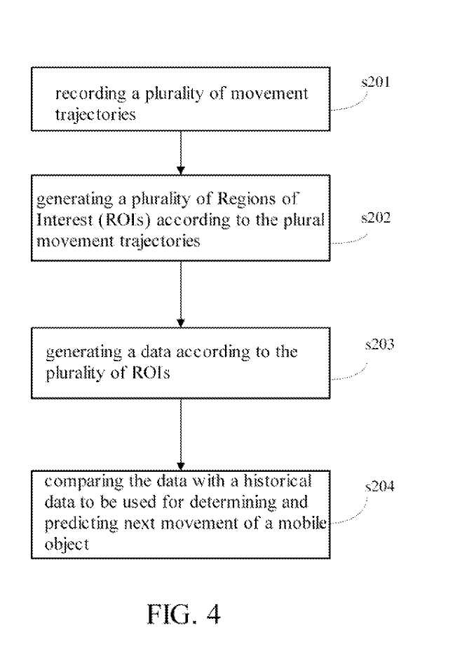

According to the embodiments of the present disclosure, there can be a plurality of movement trajectories of multiple mobile objects being collected and recorded at the same time, and after analyzing the plural movement trajectories, a plurality of ROIs of multi-level hierarchical structure as well as the corresponding relationships between ROIs in different levels can be generated and used to establish a multi-dimensional trajectory database of various accuracies that is to be used for predicting movement of a mobile object. Please refer to FIG. 4, which is a flow chart depicting steps performed in a method for analyzing movement trajectories according to an exemplary embodiment of the present disclosure, that includes a steps for comparing the multi-level data with a historical data so as to determine and predict the position of a mobile object. In this embodiment, the flow starts from the step s201. At the step s201, there is a plurality of movement trajectories being recorded; and then the flow proceeds to step s202. At step s202, there is a plurality of Regions of Interest (ROIs) being generated according to the movement trajectories; and then the flow proceeds to step s203. At step s203, there is a data being generated according to the plural ROIs and then the flow proceeds to step s204. At step 204, the data is compared with a historical data so as to determine and predict next movement of a mobile object.

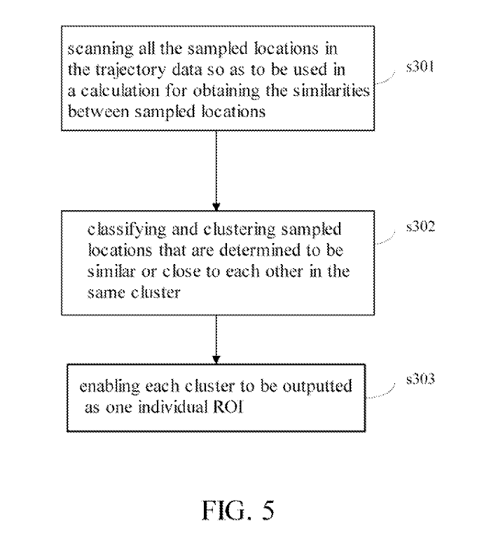

The means used for analyzing and generating the ROIs can be a clustering algorithm or a space partitioning approach method, which is a means performed based upon the similarity between different sampled locations in a movement trajectory while allowing those sampled locations that are determined to be similar or close to each other to be clustered in the same level, by the steps shown in FIG. 5. As shown in FIG. 5, at step s301, first all the sampled locations in the trajectory data is scanned so as to be used in a calculation for obtaining the similarities between sampled locations; and then the flow proceeds to step s302. In addition, the similarity can be the similarity in geographical point of view, i.e. the two sampled locations are determined to be similar since they are either being close to each other in distance or they are semantically the same, such as restaurant and fast food stop. At step s302, the sampled locations that are determined to be similar or close to each other are to be clustered in the same cluster; and then the flow proceeds to step s303. At step s303, an output is issue for defining each cluster to be one individual ROI.

The method for analyzing movement trajectories provided in the present disclosure can be divided into two parts, which are a multi-level ROI clustering part and a part for multi-level ROI structure construction and multi-level trajectory construction. In the multi-level ROI clustering part, a clustering calculation is performed using different positioning information and semantic classes as parameters with reference to their respective accuracy tolerances so as to establish a multi-level data of ROI clusters. In the part for multi-level ROI structure construction and multi-level trajectory construction, after obtaining the multi-level data of ROI clusters, an operation is performed for establishing corresponding relationships between ROIs of different levels so as to convert the original trajectories mixing a plural types of positioning signals into a multi-level ROI data of hierarchical structure, and thus to eventually establish a multi-level ROI trajectory database for all kinds of mobile services. For establishing corresponding relationships between ROIs of different levels, it is important to use the correlation between two ROIs of different levels, such as the degree of overlapping, as a criteria for determining whether to establish a corresponding relationship of the two ROIs. Thereby, a multi-level ROI data of hierarchical structure can be obtained.

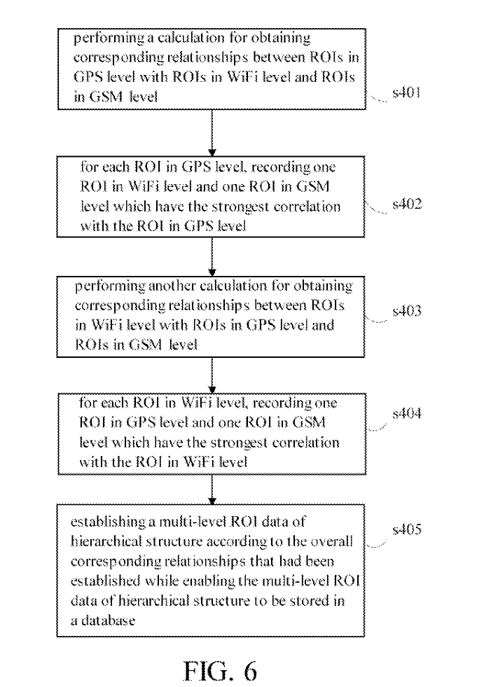

Please refer to FIG. 6, which is flow chart depicting steps for establishing a multi-level ROI data of hierarchical structure and a multi-level ROI trajectory database. In this embodiment, the ROIs of different levels are recorded and established using GPS signals, WiFi signals and GSM signals for illustration, and the flow starts from the step s401. At step s401, a calculation is performed for obtaining corresponding relationships between ROIs in GPS level with ROIs in WiFi level and ROIs in GSM level; and then the flow proceeds to step s402. At step s402, for each ROI in GPS level, one ROI in WiFi level and one ROI in GSM level whichever have the strongest correlation with the ROI in GPS level are selected and recorded; and then the flow proceeds to step s403. It is noted that the correlation can be defined as the degree of overlapping between two ROIs at different levels, and the degree of overlapping must exceed a specific value for allowing the corresponding relationship between the two ROIs to be established. At step s403, another calculation is performed for obtaining corresponding relationships between ROIs in WiFi level with ROIs in GPS level and ROIs in GSM level; and then the flow proceeds to step s404. At step s404, for each ROI in WiFi level, one ROI in GPS level and one ROI in GSM level whichever have the strongest correlation with the ROI in WiFi level are selected and recorded; and then the flow proceeds to step s405. At step 405, a multi-level ROI data of hierarchical structure is established according to the overall corresponding relationships that had been established and then the multi-level ROI data of hierarchical structure is stored in a database.

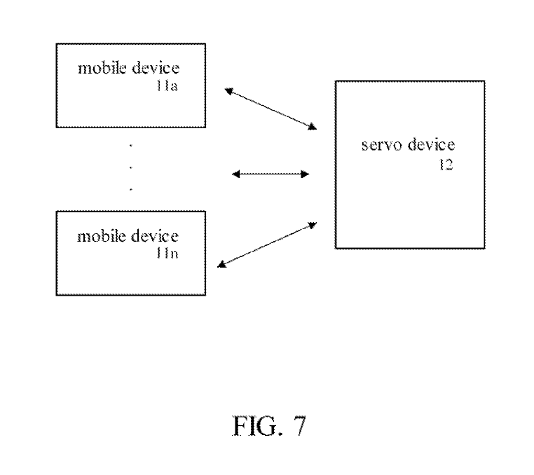

Please refer to FIG. 7, which is a block diagram showing a system for analyzing movement trajectories according to an exemplary embodiment of the present disclosure. As shown in FIG. 7, the trajectory analysis system comprises: a plurality of mobile devices 11a˜11n and a servo device 12, in which the servo device 12 has a multi-level ROI data of hierarchical structure stored therein. Operationally, the plural mobile devices 11a˜11n can be attached respectively to mobile objects for registering their respective moving trajectories as each moving trajectory is composed of a plurality of positioning signals from various sources of different accuracies and semantic classes for each and every sampled locations, and then the plural trajectories is transmitted to the servo device 12. On the other hand, each of the plural mobile devices 11a˜11n is enabled to obtain and record a sequence of positioning signals including sampled locations and time stamps along the route of its corresponding mobile object via interfacing or signal transmission to be used for generating a movement trajectory for the mobile object after sequencing the plural positioning signals by time, and then the mobile devices 11a˜11n will upload their respective movement trajectories to the servo device 12. After receiving the plural movement trajectories from the mobile devices 11a˜11n, the servo device 12 will perform a calculation for generating a plurality of ROIs according to the plural movement trajectories, and then generating a data according to the plural ROIs. In addition, the servo device 12 is further being enabled to perform an analysis upon the plural trajectories for establish a multi-level ROI data and also establishing corresponding relationships between ROIs of different levels, and thereby, constructing a multi-level ROI data of hierarchical structure. It is noted that the connection between the mobile devices 11a˜11n and the servo device 12 can be achieved through either a wired means or a wireless means. Moreover, the servo device 12 is used for collecting a plurality of such multi-level ROI data of hierarchical structure so as to construct a trajectory data of hierarchical structure including information of zip code, arriving time and departure time, etc.

In an embodiment, the positioning information that can be obtained by any mobile device of the present disclosure can be a GPS coordinate, such as (25.033485, 121.530195), and for the obtaining of semantic class, it can be achieved by connection either each mobile device or the servo device to a geography database or other information database whichever contains semantic classification for the area where the trajectory analysis system is used, and thereby, operationally, either each mobile device is enabled to obtain the semantic class relating to its current position directly, or each mobile device is enabled to transmit the position coordinate of its current position to the servo device, and the servo device that is connected to the geography database convert the position coordinate to a corresponding semantic class and then send the semantic class back to the mobile device.

For instance, in an embodiment, at 18:20, a position coordinate (25.033485, 121.530195) of a user is obtained by a mobile device attached to the user; and at 19:40, the servo device that is connected to an electronic invoice system registers a billing record of the user as the user had purchase a watch at a stop in Taipei 101 building. Thereby, the servo device that is also connected to a geography database is able to convert the billing record into a record of position coordinate of (25.033485, 121.564099) with time stamp, and then construct a trajectory of the user as following: 18:20, (25.033485, 121.530195)→19:40, (25.033485, 121.564099). Moreover, the servo device can further construct a multi-level data using the aforesaid original trajectory according to the geographical ROI of district as following: 18:20 at Da'an District→19:40 at Xinyi District. In addition, the servo device can further construct a multi-level data using the aforesaid original trajectory according to ROI of semantic class as flowing: 18:20 at Restaurant→19:40 at Department store. It is noted from this embodiment that the detection of mobile device is not the only source of positioning information of the user, and thus the positioning information of the user can be obtained directly by the servo device from other information sources. In this embodiment, the other information source is the electronic invoice system, and as the servo device is connected to the electronic invoice system and also to a geography database, it is able to convert the billing record into a positioning information with high accuracy.

In a method for analyzing movement trajectories of the present disclosure, an analysis of multi-level clustering is used for converting trajectories mixing a plural types of positioning signals into a multi-level ROI data of hierarchical structure, by that in addition to the analysis of a simple trajectory resulting from only one type of positioning signal, the method of the present disclosure can be used for analyzing more complex trajectories that are resulting from the mixing of a plural types of positioning signals of different accuracies. Therefore, it is an improved information analysis method suitable for a variety of modern positioning services.

Operationally, the method for analyzing movement trajectories of the present disclosure is able to obtain a variety of positioning signals, semantic classifications, time stamps for every sampled location along the route of each mobile object via all kinds of interfacing means, and then to sequence all those positioning signals, semantic classifications, time stamps for every sampled location by time so as to generate a trajectory. Thereafter, the trajectories are analyzed and converted into multi-level ROI data of hierarchical structure whereas the corresponding relationships between different levels in the hierarchical structure are established, and then all the multi-level ROI data of hierarchical structure are stored so as to construct a multi-level trajectory database of various sources of different accuracies.

The method of the present disclosure is able to obtain positioning information via a connection to a billing system in a store, in a manner that when a user is performing a purchase transaction in the shopping, the positioning information of the user can be obtained either at the time when the RFID tag or QR-Code of the good being purchase is scanned, or at the time when the billing record of this purchase is transmitted to the servo device by the billing system.

Moreover, using the method for analyzing movement trajectories of the present disclosure, ROIs of different accuracies can be converted back and forth between one another. For instance, the ROI in GPS level can be converted into ROI in GSM level or ROI in semantic level. Thereby, a user is able to locate his/her ROI of a specific accuracy at will or according to the device capability.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A method for analyzing movement trajectories, comprising the steps of:
recording a plurality of movement trajectories and each movement trajectory including information of position coordinate and classification;
generating a plurality of Regions of Interest (ROIs) according to the plural movement trajectories; and
generating a plurality of corresponding relationships and a data according to the plurality of ROIs.

2. The method of claim 1, wherein the information of position coordinate is obtained based upon at least two signals of different accuracies.

3. The method of claim 1, wherein the data is a multi-level data of hierarchical structure.

4. The method of claim 2, wherein the plural corresponding relationships are relationships between the plural ROIs and the at least two signals.

5. The method of claim 2, wherein the at least two signals of different accuracies are two signals selected from the group consisting of: a GPS signal, a WiFi signal, a GSM signal, a GPRS signal, a QR-Code with location information, a NFC signal and a RFID signal.

6. The method of claim 1, further comprising a step of:
comparing the data with a historical data.

7. A system for analyzing movement trajectories, comprising:
a database, configured to store a plurality of movement trajectories, each including information of position coordinate and classification; and
a servo device, configured to generate a plurality of Regions of Interest (ROIs) according to the plural movement trajectories and then to generate a plurality of corresponding relationships and a data according to the plurality of ROIs.

8. The system of claim 7, wherein the information of position coordinate is obtained based upon at least two signals of different accuracies.

9. The system of claim 7, wherein the data is a multi-level data of hierarchical structure.

10. The system of claim 8, wherein the plural corresponding relationships are relationships between the plural ROIs and the at least two signals.

11. The system of claim 8, wherein the at least two signals of different accuracies are two signals selected from the group consisting of: a GPS signal, a WiFi signal, a GSM signal, a GPRS signal, a QR-Code with location information, a NFC signal and a RFID signal.

12. The system of claim 7, wherein the servo device is enabled to perform a comparison between the data and a historical data.
